(19) United States
(12) Patent Application Publication
(10) Pub. No.: US 2003/0072992 A1
(43) Pub. Date: Apr. 17, 2003

(54) Battery pack

(75) Inventors: Suetaka Okamoto, Utsunomiya-Shi (JP); Koichi Fujitsuka, Utsunomiya-Shi (JP)

Correspondence Address: ARMSTRONG,WESTERMAN & HATTORI, LLP, 1725 K STREET, NW, SUITE 1000, WASHINGTON, DC, 20006, US

(73) Assignee: NEC TOKIN TOCHIGI, LTD., Utsunomiya-Shi (JP)

(21) Appl. No.: 10/269,862

(22) Filed: Oct. 15, 2002

(30) Foreign Application Priority Data
Oct. 16, 2001 (JP) 2001-318126

(51) Int. Cl. H01M 2/12

(52) U.S. Cl. 429/53; 429/82; 429/88

(57) ABSTRACT

The invention provides a battery pack comprising a battery using a battery can, wherein the operation of a pressure relief valve is not adversely affected by an insulating protective member. The insulating protective member is attached on the surface of the battery can provided with the pressure relief valve, having at least one aperture located above the pressure relief valve and in communication with the periphery of said pressure relief valve.

### BACKGROUND OF THE INVENTION

The present invention relates generally to a battery pack, and more particularly to a battery pack in which a battery comprising a battery can is provided at its surface with a battery protective member for insulating the electrode terminal, etc. of the battery.

Batteries of high change/recharge capacity densities, for instance, lithium ion batteries are little used by themselves; they are ordinarily used in the form of a battery pack to be mounted on battery-powered equipments. One such pack comprises a synthetic resin case or enclosure including built-in components such as a charge/recharge protective circuit for cutting off an electric current to protect a battery when an excessive current is induced due to short-circuiting of battery terminals, etc., or at the time of overdischarge resulting from an overheated battery, etc.

In the battery encased in the battery pack, an electrode terminal formed on the battery can via an insulating material and the battery can work as electrode terminals.

A surface of the battery in the vicinity of the electrode terminals, etc. are covered with an insulating protective member so as to keep these electrode terminals or electrically conductive connection tabs led therefrom and having opposite polarities from coming into contact with each other to form a short-circuit.

FIGS. 3(A) and 3(B) are illustrative of one exemplary battery pack in which an insulating protective member is attached over the surface of a battery.

More specifically, FIG. 3(A) is illustrative of the battery to be encased in a battery pack. A battery shown generally at 2 is produced by loading a battery element in a battery can 3 from its opening and then attaching a battery header 4 to the battery can followed by sealing up the periphery thereof. It is here noted that the battery 2 comprises a battery element constructed of a roll form of cathode and anode located in an opposite relation to each other via a separator.

A metal sheet of the battery header 4 is provided via an insulating member with an electrode terminal 5 of polarity opposite to that of the battery can 2.

The battery header 4 is also provided with a pressure relief valve 6 defined by a thinner portion or the like, so that when the internal pressure of the battery rises due to abnormal battery reactions caused by shorting of battery's terminals, etc., pressures inside the battery are relieved to ward off a battery rupture, etc.

FIG. 3(B) is illustrative of a battery pack. A battery pack shown generally at 1 comprises an enclosure 7 molded of a synthetic resin, as shown by a broken line. In this enclosure 7, there are encased built-in components 8 such as a circuit board including a protective circuit for protecting a battery 2 against overcharging and over-discharging, and the enclosure 7 is provided at its surface with an electrically conductive connection terminal 9.

An insulating protective member 10 is applied over the outer surface of the battery inclusive of the battery header but except a region of the electrode terminal to which a tab is to be joined, while an electrically conductive connection tab 11 connected to the electrode terminal of the battery is joined to the built-in components 8.

As shown in FIG. 3(B), however, the insulating protective member 10 is extended to and placed over the upper portion of a pressure relief valve 6, and so it is impossible to totally eliminate a possibility that a battery rupture, etc. may occur if anything is wrong, because that insulating protective member renders swift operation of the pressure relief valve difficult.

The primary object of the present invention is to provide a battery pack that ensures that a pressure relief valve is put in operation while the operation of the pressure relief valve is not affected by an insulating protective member mounted over the surface of a battery within the battery pack, thereby foreclosing any risk of battery ruptures, etc.

### BRIEF DESCRIPTION OF THE DRAWINGS

FIGS. 1(A) and 1(B) are illustrative of one embodiment of the battery pack according to the invention.

FIGS. 2(A), 3(B) and 2(C) are illustrative of an insulating protective member provided on a battery header.

FIGS. 3(A) and 3(B) are illustrative of one example of the battery pack in which an insulating protective material is applied over the surface of a battery.

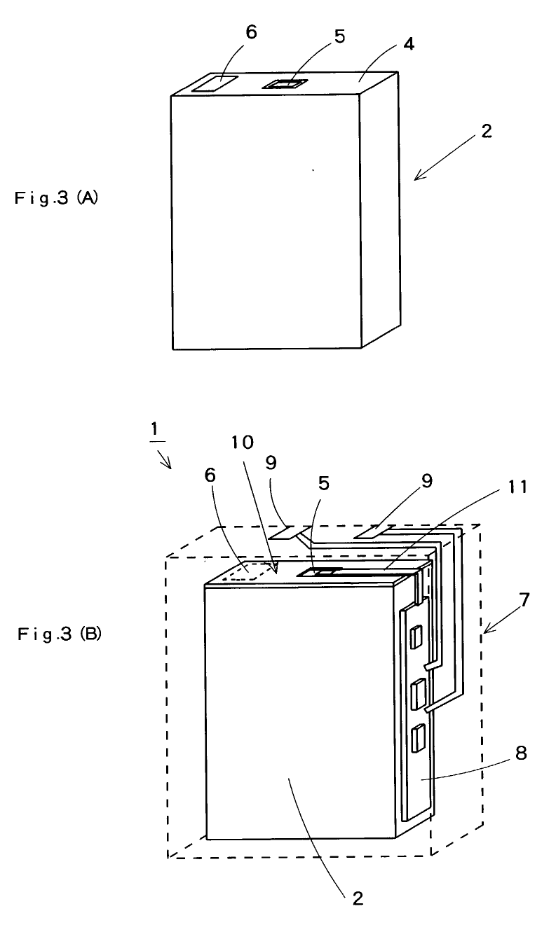

### SUMMARY OF THE INVENTION

The object of the present invention can be accomplished by the provision of a battery pack comprising a battery using a battery can, wherein an insulating protective member is attached on a surface of the battery can having a pressure relief valve, said insulating protective member having at least one opening or aperture located above said pressure relief valve and in communication with the pressure relief valve.

In the battery pack of the invention, a plurality of such apertures formed in the insulating protective member are located at symmetric positions.

In the battery pack of the invention, the insulating protective member is made of heat-resistant synthetic paper.

### DESCRIPTION OF THE PREFERRED EMBODIMENT

According to the present invention, it has been now found that if an insulating protective member attached to a battery pack for the purpose of preventing any shorting of an battery can and an electrically conductive connection tab joined to the electrode terminal of the battery can as well as for the purpose of preventing any oxidation of the surface of a battery is specially configured, it is then possible to prevent that insulating protective member from having any adverse influence on the operation of a pressure relief valve.

The present invention is now explained with reference to the accompanying drawings.

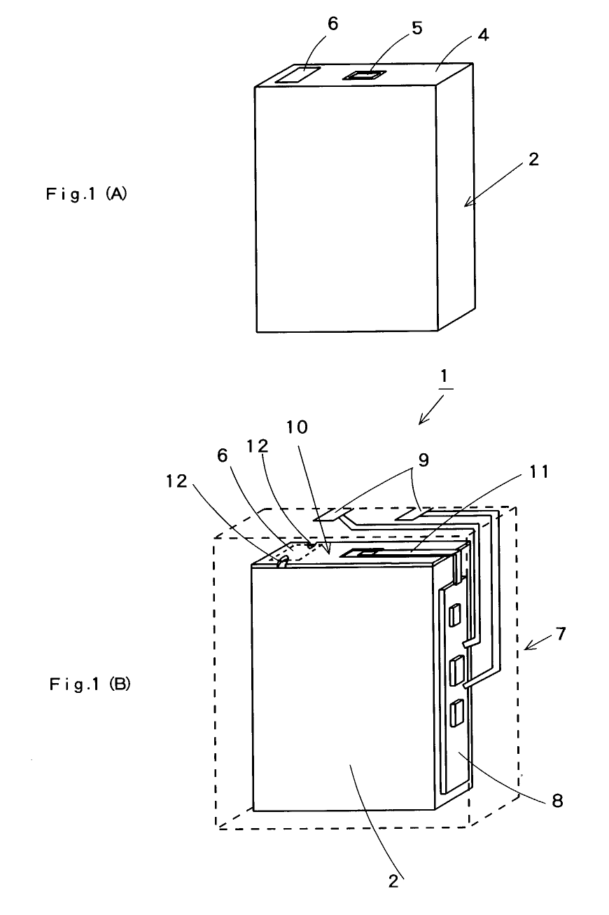

FIGS. 1(A) and 1(B) are illustrative of one embodiment of the battery pack of the invention.

FIG. 1(A) is illustrative of the battery encased in the battery pack. A battery shown generally at 2 is produced by loading a battery element in a battery can 3 from its opening and then attaching a battery header 4 to the battery can followed by sealing up the periphery thereof. It is here noted that the battery 2 comprises a battery element constructed of a roll form of cathode and anode located in an opposite relation to each other via a separator.

A metal sheet of the battery header 4 is provided via an insulating member with an electrode terminal 5 of polarity opposite to that of the battery can 2.

The battery header 4 is also provided with a pressure relief valve 6 defined by a thinner portion or the like, so that when the internal pressure of the battery rises due to abnormal battery reactions caused by shorting of battery's terminals, etc., pressures inside the battery are relieved to ward off a battery rupture or other breakdown.

FIG. 1(B) is illustrative of the battery pack of the present invention.

A battery pack shown generally at 1 comprises an enclosure 7 molded of a synthetic resin, as shown by a broken line. Encased in this enclosure 7 is the battery 2 together with built-in components 8 such as a circuit board including a protective circuit for protecting a battery 2 against overcharging and over-discharging, and the enclosure 7 is provided at its surface with an electrically conductive connection terminal 9.

An insulating protective member 10 is applied over the outer surface of the battery inclusive of the battery header but except a region of the electrode terminal to which a tag is to be joined, while an electrically conductive connection tab 11 connected to the electrode terminal of the battery is joined to the built-in components 8.

While the insulating protective member 10 is attached to the surface having the pressure relieve valve 6, it is understood that at a location positioned on the pressure relieve valve, there is an aperture 12 in communication with the outer periphery of the surface having the pressure relieve valve 6.

Thus, that aperture is in communication with the outer periphery of the surface having the pressure relieve valve, so that when the internal pressure of the battery becomes high enough to put the pressure relieve valve into operation, the pressure is immediately relieved from the aperture 12, and so a battery rupture or other dangerous accident can be avoided.

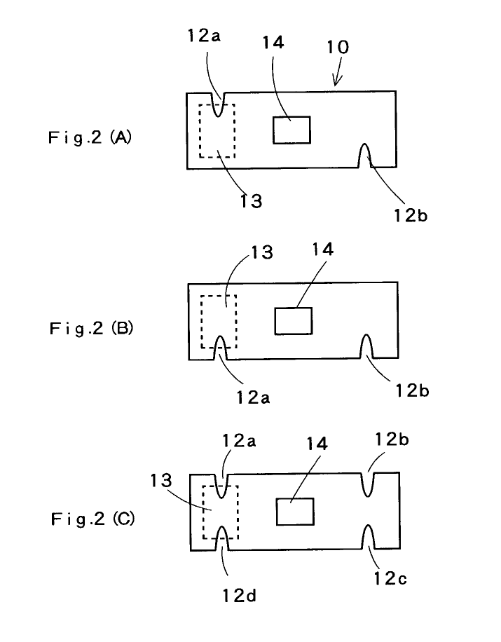

FIGS. 2(A), 2(B) and 2(C) are illustrative of the insulating protective member attached to the battery header.

In one embodiment shown in FIG. 2(A), an aperture 12a is located at a position 13 of an insulating protective member 10, which corresponds to a pressure relieve valve where that member 10 is attached to a battery pack. Another aperture 12b is located at a position that is diagonal with respect to the aperture 12a and symmetric with respect to the center of the insulating protective member 10, and an opening 14 for an electrode terminal is located at that center.

This ensures that even when the insulating protective member 10 is set in the reverse direction upon attachment of the insulating protective member to the battery pack, either one of the apertures is located at the position of the pressure relieve valve of the battery.

In another embodiment shown in FIG. 2(B), too, two apertures 12a and 12b are located at symmetric positions. This again ensures that even when an insulating protective member 10 is set in the reverse direction upon attachment of the insulating protective member to the battery pack, either one of the apertures is located at the position of the pressure relieve valve of the battery.

In yet another embodiment shown in FIG. 2(C), four apertures 12a, 12b, 12c and 12d are located at symmetric positions. Because there are always two apertures at a pressure relieve valve position 13, pressure can be relieved much more swiftly.

Although varying with battery size, these apertures should preferably be sized to be 0.5 mm to 1.0 mm in width and 0.5 mm to 1.00 mm in length for batteries having a thickness of a few mm.

For the insulating protective member, for instance, aromatic polyamide synthetic paper that has insulating properties as well as resistance to heat ensuing from welding, soldering, etc., e.g., Nomex made by Du Pont may be used. The insulating protective member may be applied over the surface of a battery by means of an adhesive material.

In the battery pack of the present invention, the insulating protective member used for imparting insulation to the surface of a battery and protecting the battery is provided at a position located at a battery's pressure relief valve with at least one aperture in communication with the outer periphery of a surface provided with the battery's pressure relief valve. This enables the pressure relief valve to be swiftly put into operation without any adverse influence of the attached insulating protective member on that operation. Thus, the present invention can provide a battery pack with great safety.

What we claim is:

1. A battery pack comprising a battery using a battery can, wherein an insulating protective member is attached on a surface of the battery can having a pressure relief valve, said insulating protective member having at least one aperture located above said pressure relief valve and in communication with a periphery of said pressure relief valve.

2. The battery pack according to claim 1, wherein the insulating protective member is made of a heat-resistant synthetic paper.

3. The battery pack according to claim 1, wherein a plurality of such apertures formed in the insulating protective member are located at symmetric positions.

4. The battery pack according to claim 2, wherein a plurality of such apertures formed in the insulating protective member are located at symmetric positions.
